(19) United States
(12) Patent Application Publication
(10) Pub. No.: US 2019/0104449 A1
(43) Pub. Date: Apr. 4, 2019

(54) APPARATUS AND METHOD RELATED TO RADIO ACCESS NETWORK

(71) Applicant: NEC CORPORATION, Tokyo (JP)

(72) Inventor: Kengo OKETANI, Tokyo (JP)

(73) Assignee: NEC CORPORATION, Tokyo (JP)

(21) Appl. No.: 16/126,439

(22) Filed: Sep. 10, 2018

(30) Foreign Application Priority Data
Sep. 29, 2017 (JP) 2017-189892

(51) Int. Cl. H04W 36/00; H04L 25/02; H04W 36/08; H04W 24/10; H04B 7/06; H04L 5/00; H04W 36/30

(52) U.S. Cl. CPC H04W 36/0072; H04L 25/0224; H04W 36/08; H04W 24/10; H04W 36/30; H04B 7/0626; H04L 5/0055; H04W 36/0085; H04B 7/0617

(57) ABSTRACT

To enable a prompt increase in throughput of a terminal apparatus immediately after handover. An apparatus of the present invention includes: an acquisition unit 145 configured to acquire a response message for a handover message from a source base station (base station 200) of handover of a terminal apparatus 300, the response message including information of uplink resources related to measurement for the terminal apparatus 300; and a first communication processing unit 141 configured to transmit the response message for the handover message to the source base station (base station 200).

### BACKGROUND

### Technical Field

The present disclosure relates to an apparatus and a method related to a radio access network.

This application is based upon and claims the benefit of priority from Japanese patent application No. 2017-189892, filed on Sep. 29, 2017, the disclosure of which is incorporated herein in its entirety by reference.

### Background Art

To enable a rapid capacity increase of mobile networks, a frequency band of a several ten gigahertz band, which is higher than currently-used frequency bands of a several hundred megahertz band and a several gigahertz band, will probably be used in addition to the currently-used frequency bands. Especially in the fifth generation (5G), for the use of such bands, discussion has been made about the use of a large number of antennas to form highly directional beams for transmission of signals to users.

In such a higher frequency band, in order to compensate a large propagation loss, it is conceivable that all downlink signals/downlink channels including not only system information and paging information but also a common pilot signal or a reference signal and the like are transmitted through beamforming. Similarly, in the uplink, in order to compensate a propagation loss, it is conceivable that all uplink signals/uplink channels are received through beamforming.

For example, Japanese Unexamined Patent Application Publication (Translation of PCT Application) No. 2014-531852 (PTL 1) discloses a technique for including a downlink beam ID and an uplink beam ID in a handover request message to be transmitted from a source base station of handover of a terminal apparatus to a target base station of the handover. Furthermore, according to PTL 1, the downlink beam ID is used to indicate a downlink beam for transmitting data to the terminal apparatus after the handover, and the uplink beam ID is used to indicate an uplink beam for receiving data from the terminal apparatus after the handover. In this way, an operation for selecting a beam in handover may be omitted, which consequently may reduce a delay in handover.
[PTL 1] Japanese Unexamined Patent Application Publication (Translation of PCT Application) No. 2014-531852

### SUMMARY

However, in the technique disclosed in PTL 1 described above and the like, the target base station, which is the destination of handover, takes time for data channel (Data CH) assignment taking account of the terminal apparatus immediately after the handover. This causes a problem that it is difficult to increase the throughput of the terminal apparatus immediately after the handover.

An example object of the present invention is to provide an apparatus and a method that enable a prompt increase in throughput of a terminal apparatus immediately after handover.

According an example aspect of the present invention, an apparatus comprises: a memory storing a program; and one or more processors configured to execute the program to: acquire a response message for a handover message from a source base station of handover of a terminal apparatus, the response message including information of uplink resources related to measurement for the terminal apparatus; and transmit the response message for the handover message to the source base station.

According an example aspect of the present invention, an apparatus comprises: a memory storing a program; and one or more processors configured to execute the program to: receive a response message for a handover message transmitted from a target base station of handover of a terminal apparatus, the response message including information of uplink resources related to measurement for the terminal apparatus; and transmit, to the terminal apparatus, a handover command message including information corresponding to the information of the uplink resources related to the measurement for the terminal apparatus.

According an example aspect of the present invention, a method includes: acquiring a response message for a handover message from a source base station of handover of a terminal apparatus, the response message including information of uplink resources related to measurement for the terminal apparatus; and transmitting the response message for the handover message to the source base station.

According to the present invention, it is possible to promptly increase throughput of a terminal apparatus immediately after handover. Note that, according to the present invention, instead of or together with the above effect, other effects may be exerted.

### BRIEF DESCRIPTION OF THE DRAWINGS

FIG. 1 is an explanatory diagram illustrating an example of a schematic configuration of a system 1 according to a first example embodiment.

FIG. 2 is a block diagram illustrating an example of a schematic configuration of a base station 100 according to the first example embodiment.

FIG. 3 is a block diagram illustrating an example of a schematic configuration of a base station 200 according to the first example embodiment.

FIG. 4 is a block diagram illustrating an example of a schematic configuration of a terminal apparatus 300 according to the first example embodiment.

FIG. 5 is an explanatory diagram for describing an example of multiple beams on which a reference signal is transmitted.

FIG. 6 is an explanatory diagram for describing an example of a measurement report of the terminal apparatus 300.

FIG. 7 is a sequence diagram for describing an example of a schematic flow of processing according to the first example embodiment.

FIG. 8 is a sequence diagram for describing an example of a schematic flow of processing according to a comparative example of the first example embodiment.

FIG. 9 is an explanatory diagram illustrating an example of a schematic configuration of a system 2 according to a second example embodiment.

FIG. 10 is a block diagram illustrating an example of a schematic configuration of a base station 500 according to the second example embodiment.

FIG. 11 is a block diagram illustrating an example of a schematic configuration of a base station 600 according to the second example embodiment.

FIG. 12 is a block diagram illustrating an example of a schematic configuration of a terminal apparatus 700 according to the second example embodiment.

### DESCRIPTION OF THE EXAMPLE EMBODIMENTS

Hereinafter, example embodiments of the present invention will be described in detail with reference to the accompanying drawings. Note that, in the present description and drawings, elements to which the same or similar descriptions are applicable are denoted by the same reference signs, whereby overlapping descriptions may be omitted.

Descriptions will be given in the following order.
1. Overview of Example Embodiments
2. First Example Embodiment
   2.1. Configuration of System
   2.2. Configuration of Base Station 100
   2.3. Configuration of Base Station 200
   2.4. Configuration of Terminal Apparatus 300
   2.5. Technical Features
3. Second Example Embodiment
   3.1. Configuration of System
   3.2. Configuration of Base Station 500
   3.3. Configuration of Base Station 600
   3.4 Configuration of Terminal Apparatus 700
   3.5. Technical Features
4. Other Example Embodiments

### 1. Overview of Example Embodiments

First, an overview of example embodiments of the present invention will be described.

(1) Technical Problems

To enable a rapid capacity increase of mobile networks, a frequency band of a several ten gigahertz band, which is higher than currently-used frequency bands of a several hundred megahertz band and a several gigahertz band, will probably be used in addition to the currently-used frequency bands. Especially in the fifth generation (5G), for the use of such bands, discussion has been made about the use of a large number of antennas to form highly directional beams for transmission of signals to users.

In such a higher frequency band, in order to compensate a large propagation loss, it is conceivable that all downlink signals/downlink channels including not only system information and paging information but also a common pilot signal or a reference signal and the like are transmitted through beamforming. Similarly, in the uplink, in order to compensate a propagation loss, it is conceivable that all uplink signals/uplink channels are received through beamforming.

For example, patent literature (Japanese Unexamined Patent Application Publication (Translation of PCT Application) No. 2014-531852) discloses a technique for including a downlink beam ID and an uplink beam ID in a handover request message to be transmitted from a source base station of handover of a terminal apparatus to a target base station of the handover. Furthermore, according to the above patent literature, the downlink beam ID is used to indicate a downlink beam for transmitting data to the terminal apparatus after the handover, and the uplink beam ID is used to indicate an uplink beam for receiving data from the terminal apparatus after the handover. In this way, an operation for selecting a beam in handover may be omitted, which consequently may reduce a delay in handover.

However, in the technique disclosed in the above patent literature and the like, the target base station, which is the destination of handover, takes time for data channel (Data CH) assignment taking account of the terminal apparatus immediately after the handover. This causes a problem that it is difficult to increase the throughput of the terminal apparatus immediately after the handover.

To address this problem, it is desirable to enable a prompt increase in throughput of a terminal apparatus immediately after handover.

(2) Technical Features

In the example embodiments of the present invention, for example, a target base station of handover acquires a response message for a handover message from a source base station of the handover of a terminal apparatus, the response message including information of uplink resources related to measurement for the terminal apparatus, and transmits the response message for the handover message to the source base station.

Moreover, for example, the source base station receives, from the target base station, the response message including the information of the uplink resources related to the measurement for the terminal apparatus, and transmits, to the terminal apparatus, a handover command message including information corresponding to the information of the uplink resources related to the measurement for the terminal apparatus.

Furthermore, for example, the terminal apparatus receives, from the source base station, the handover command message including the information of the uplink resources related to the measurement for the terminal apparatus, and transmits, to the target base station, a signal by using the information of the uplink resources related to the measurement.

With this configuration, for example, it is possible to reduce time for data channel (Data CH) assignment taking account of the terminal apparatus immediately after handover. This consequently enables a prompt increase in throughput of a terminal apparatus immediately after handover.

Note that the above-described technical features are concrete examples of the example embodiments of the present invention, and, of course, the example embodiments of the present invention are not limited to the above-described technical features.

### 2. First Example Embodiment

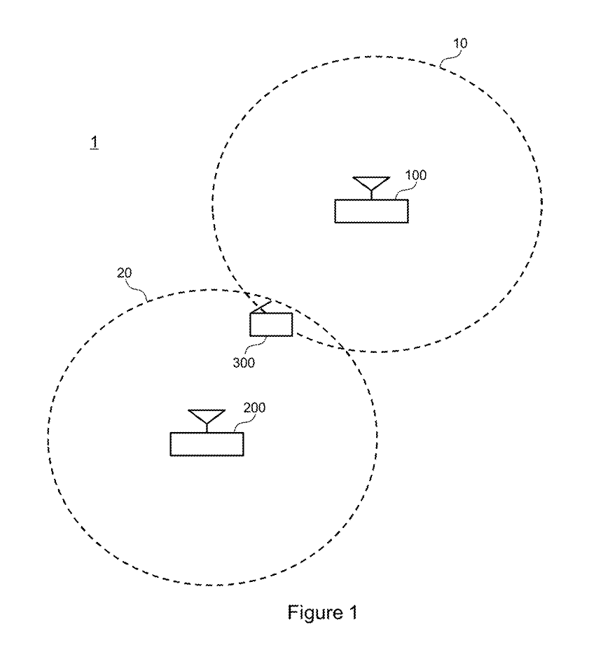

Next, a description will be given of a first example embodiment of the present invention with reference to FIG. 1 to FIG. 8.

<2.1. Configuration of System>

With reference to FIG. 1, an example of a configuration of a system 1 according to the first example embodiment will be described. FIG. 1 is an explanatory diagram illustrating an example of a schematic configuration of the system 1 according to the first example embodiment. According to FIG. 1, the system 1 includes a base station 100, a base station 200, and a terminal apparatus 300.

For example, the system 1 may be a system conforming to Third Generation Partnership Project (3GPP) standards. More specifically, for example, the system 1 may be a system conforming to the Long Term Evolution (LTE)/LTE-Advanced and/or the System Architecture Evolution (SAE) standards/specifications. Alternatively, the system 1 may be a system conforming to the fifth generation (5G)/New Radio (NR) standards/specifications. The system 1 is, of course, not limited to these examples.

(1) Base Station 100

The base station 100 is a Radio Access Network (RAN) node and performs wireless communication with a terminal apparatus (e.g., terminal apparatus 300) located in a coverage area 10. In the first example embodiment, the base station 100 performs wireless communication through beamforming.

The base station 100 may be an evolved Node B (eNB) or a generation Node B (gNB) in 5G. The base station 100 may include a plurality of units (or a plurality of nodes). The plurality of units (or the plurality of nodes) may include a first unit (or a first node) configured to perform higher protocol layer processing and a second unit (or a second node) configured to perform lower protocol layer processing. As an example, the first unit may be referred to as a center/central unit (CU), and the second unit may be referred to as a distributed unit (DU) or an access unit (AU). As another example, the first unit may be referred to as a digital unit (DU), and the second unit may be referred to as a radio unit (RU) and a remote unit (RU). The digital unit (DU) may be a base band unit (BBU), and the RU may be a remote radio head (RRH) or a remote radio unit (RRU). The terms for the first unit (or the first node) and the second unit (or the second node) are, of course, not limited to these examples. Alternatively, the base station 100 may be a single unit (or a single node). In this case, the base station 100 may be one of the plurality of units described above (e.g., one of the first unit and the second unit) and may be connected to another one of the plurality of units (e.g., the other one of the first unit and the second unit).

(2) Base Station 200

Similarly to the base station 100, the base station 200 is a node configured to perform wireless communication with a terminal apparatus and performs wireless communication with a terminal apparatus (e.g., terminal apparatus 300) located in a coverage area 20.

In the first example embodiment, for example, the base station 200 performs, similarly to the base station 100, wireless communication with a terminal apparatus through beamforming. Alternatively, the base station 200 may perform wireless communication with a terminal apparatus through beamforming in a manner different from that of the base station 100 or may perform wireless communication without beamforming.

(3) Terminal Apparatus 300

The terminal apparatus 300 performs wireless communication with the base stations. For example, the terminal apparatus 300 performs wireless communication with the base station 100 in the case of being located in the coverage area 10 and performs wireless communication with the base station 200 in the case of being located in the coverage area 20.

In particular, in the first example embodiment, handover of the terminal apparatus 300 from the base station 200 to the base station 100 is performed (due to move of the terminal apparatus 300, for example). In this case, the base station 200 is a source base station of the handover, and the base station 100 is a target base station of the handover.

<2.2. Configuration of Base Station 100>

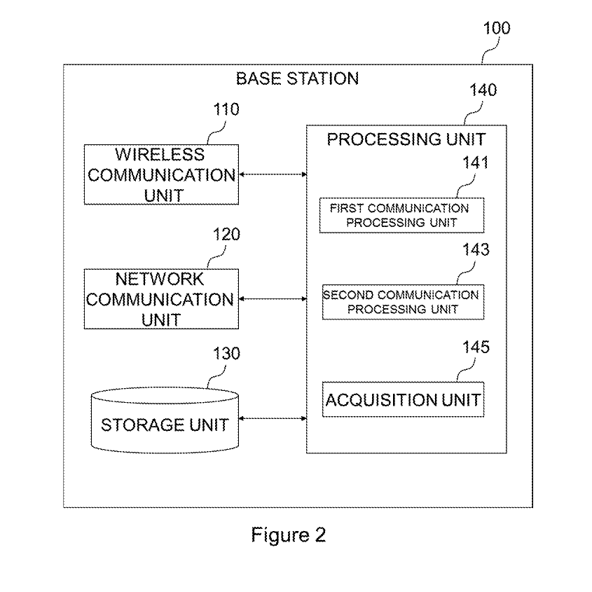

Next, a description will be given of an example of a configuration of the base station 100 according to the first example embodiment with reference to FIG. 2. FIG. 2 is a block diagram illustrating an example of a schematic configuration of the base station 100 according to the first example embodiment. According to FIG. 2, the base station 100 includes a wireless communication unit 110, a network communication unit 120, a storage unit 130, and a processing unit 140.

(1) Wireless Communication Unit 110

The wireless communication unit 110 transmits and receives signals wirelessly. For example, the wireless communication unit 110 receives a signal from a terminal apparatus and transmits a signal to the terminal apparatus.

(2) Network Communication Unit 120

The network communication unit 120 receives a signal from a backhaul and transmits a signal to the backhaul.

(3) Storage Unit 130

The storage unit 130 temporarily or permanently stores a program and parameters for operations of the base station 100 as well as various data. The program includes one or more instructions for operations of the base station 100.

(4) Processing Unit 140

The processing unit 140 provides various functions of the base station 100. The processing unit 140 includes a first communication processing unit 141, a second communication processing unit 143, and an acquisition unit 145. Note that the processing unit 140 may further include other constituent elements than these constituent elements. In other words, the processing unit 140 may also perform operations other than the operations of these constituent elements. Concrete operations of the first communication processing unit 141, the second communication processing unit 143, and the acquisition unit 145 will be described later in detail.

For example, the processing unit 140 (first communication processing unit 141) communicates with another network node(s) (e.g., the base station 200) via the network communication unit 120. For example, the processing unit 140 (second communication processing unit 143) communicates with a terminal apparatus (e.g., the terminal apparatus 300) via the wireless communication unit 110.

(5) Implementation Example

The wireless communication unit 110 may be implemented by an antenna, a radio frequency (RF) circuit, and the like, and the antenna may be a directional antenna. The network communication unit 120 may be implemented by a network adapter, a network interface card, or the like. The storage unit 130 may be implemented by a memory (e.g., a nonvolatile memory and/or a volatile memory) and/or a hard disk, and the like. The processing unit 140 may be implemented by a baseband (BB) processor and/or a different processor, and the like. The first communication processing unit 141, the second communication unit 143, and the acquisition unit 145 may be implemented by the same processor or may be implemented by separate processors. The memory (storage unit 130) may be included in such a processor (chip).

The base station 100 may include a memory configured to store a program (instructions) and one or more processors that can execute the program (instructions). The one or more processors may execute the program to perform operations of the processing unit 140 (operations of the first communication processing unit 141, the second communication processing unit 143, and the acquisition unit 145). The program may be a program for causing the processor(s) to perform operations of the processing unit 140 (operations of the first communication processing unit 141, the second communication processing unit 143, and the acquisition unit 145).

Note that the base station 100 may be virtual. In other words, the base station 100 may be implemented as a virtual machine. In this case, the base station 100 (virtual machine) may operate as a physical machine (hardware) including a processor, a memory, and the like and a virtual machine on a hypervisor.

<2.3. Configuration of Base Station 200>

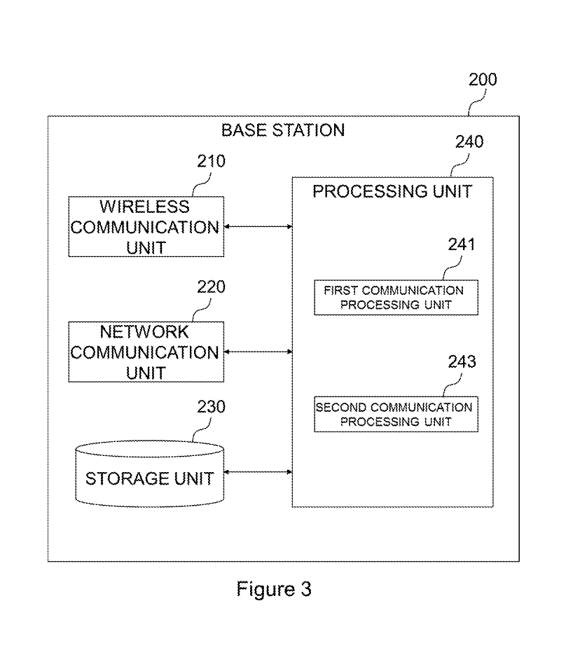

Next, a description will be given of an example of a configuration of the base station 200 according to the first example embodiment with reference to FIG. 3. FIG. 3 is a block diagram illustrating an example of a schematic configuration of the base station 200 according to the first example embodiment. According to FIG. 3, the base station 200 includes a wireless communication unit 210, a network communication unit 220, a storage unit 230, and a processing unit 240.

(1) Wireless Communication Unit 210

The wireless communication unit 210 wirelessly transmits and receives signals. For example, the wireless communication unit 210 receives a signal from a terminal apparatus and transmits a signal to the terminal apparatus.

(2) Network Communication Unit 220

The network communication unit 220 receives a signal from a backhaul and transmits a signal to the backhaul.

(3) Storage Unit 230

The storage unit 230 temporarily or permanently stores a program and parameters for operations of the base station 200 as well as various data. The program includes one or more instructions for operations of the base station 200.

(4) Processing Unit 240

The processing unit 240 provides various functions of the base station 200. The processing unit 240 includes a first communication processing unit 241 and a second communication processing unit 243. Note that the processing unit 240 may further include other constituent elements than these constituent elements. In other words, the processing unit 240 may perform other operations than the operations of these constituent elements. Concrete operations of the first communication processing unit 241 and the second communication processing unit 243 will be described later in detail.

For example, the processing unit 240 (first communication processing unit 241) communicates with another network node(s) (e.g., the base station 100) via the network communication unit 220. For example, the processing unit 240 (second communication processing unit 243) communicates with a terminal apparatus (e.g., the terminal apparatus 300) via the wireless communication unit 210.

(5) Implementation Example

The wireless communication unit 210 may be implemented by an antenna, a radio frequency (RF) circuit, and the like, and the antenna may be a directional antenna. The network communication unit 120 may be implemented by a network adapter, a network interface card, or the like. The storage unit 230 may be implemented by a memory (e.g., a nonvolatile memory and/or a volatile memory) and/or a hard disk, and the like. The processing unit 240 may be implemented by a baseband (BB) processor and/or a different processor, and the like. The first communication processing unit 241 and the second communication processing unit 243 may be implemented by the same processor or may be implemented by separate processors. The memory (storage unit 230) may be included in such a processor (chip).

The base station 200 may include a memory configured to store a program (instructions) and one or more processors that can execute the program (instructions). The one or more processors may execute the program to perform operations of the processing unit 240 (operations of the first communication processing unit 241 and the second communication processing unit 243). The program may be a program for causing the processor(s) to perform operations of the processing unit 240 (operations of the first communication processing unit 241 and the second communication processing unit 243).

Note that the base station 200 may be virtual. In other words, the base station 200 may be implemented as a virtual machine. In this case, the base station 200 (virtual machine) may operate as a physical machine (hardware) including a processor, a memory, and the like and a virtual machine on a hypervisor.

<2.4. Configuration of Terminal Apparatus 300>

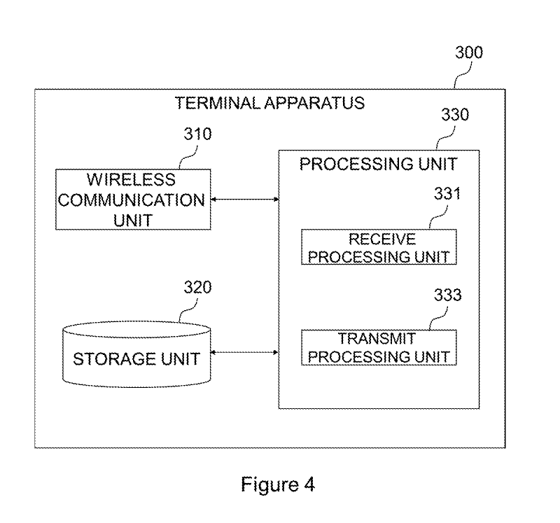

Next, with reference to FIG. 4, an example of a configuration of the terminal apparatus 300 according to the first example embodiment will be described. FIG. 4 is a block diagram illustrating an example of a schematic configuration of the terminal apparatus 300 according to the first example embodiment. According to FIG. 4, the terminal apparatus 300 includes a wireless communication unit 310, a storage unit 320, and a processing unit 330.

(1) Wireless Communication Unit 310

The wireless communication unit 310 wirelessly transmits and receives signals. For example, the wireless communication unit 310 receives a signal from a base station and transmits a signal to the base station.

(2) Storage Unit 320

The storage unit 320 temporarily or permanently stores a program and parameters for operations of the terminal apparatus 300 as well as various data.

(3) Processing Unit 330

The processing unit 330 provides various functions of the terminal apparatus 300. The processing unit 330 includes a receive processing unit 331 and a transmit processing unit 333. Note that the processing unit 330 may further include constituent elements other than these constituent elements. In other words, the processing unit 330 may perform other operations than the operations of these constituent elements. Concrete operations of the receive processing unit 331 and the transmit processing unit 333 will be described later in detail.

For example, the processing unit 330 communicates with a base station (e.g., the base station 100 and/or the base station 200) via the wireless communication unit 310.

(4) Implementation Example

The wireless communication unit 310 may be implemented by an antenna, a radio frequency (RF) circuit, and the like. The storage unit 320 may be implemented by a memory (e.g., a nonvolatile memory and/or a volatile memory) and/or a hard disk, and the like. The processing unit 330 may be implemented by a baseband (BB) processor and/or a different processor, and the like. The receive processing unit 331 and the transmit processing unit 333 may be implemented by the same processor or may be implemented by separate processors. The memory (storage unit 320) may be included in such a processor (chip) or may be provided external to the one or more processors. As an example, the processing unit 330 may be implemented in a system on chip (SoC).

The terminal apparatus 300 may include a memory configured to store a program (instructions) and one or more processors that can execute the program (instructions). The one or more processors may execute the program to perform operations of the processing unit 330 (operations of the receive processing unit 331 and the transmit processing unit 333). The program may be a program for causing the processor(s) to perform operations of the processing unit 330 (operations of the receive processing unit 331 and the transmit processing unit 333).

<2.5. Technical Features>

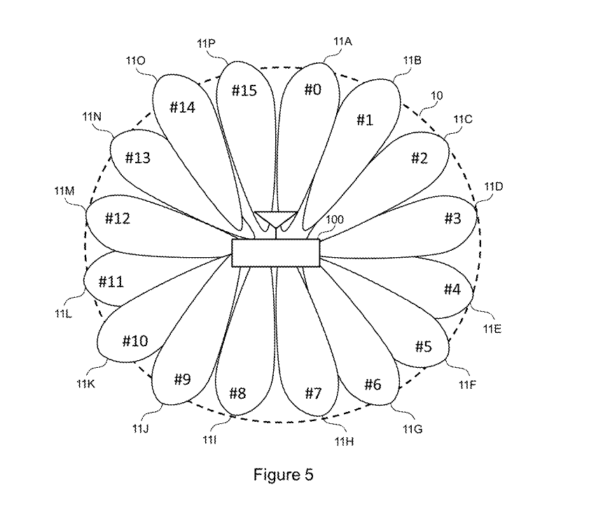

Next, technical features of the first example embodiment will be described with reference to FIG. 5 to FIG. 8.

In the first example embodiment, the base station 100 (acquisition unit 145) acquires a response message for a handover message from a source base station (base station 200) of handover of the terminal apparatus 300, the response message including information of uplink resources related to measurement for the terminal apparatus 300. Then, the base station 100 (first communication processing unit 141) transmits the response message for the handover message to the source base station (base station 200).

The information of the uplink resources related to the measurement for the terminal apparatus 300 is information to be transmitted from the source base station (base station 200) to the terminal apparatus 300.

Specifically, the base station 200 (first communication processing unit 241) receives, from a target base station (base station 100) of the handover of the terminal apparatus 300, the response message including the information of the uplink resources related to the measurement for the terminal apparatus 300. The base station 200 (second communication processing unit 243) then transmits, to the terminal apparatus 300, a handover command message including information corresponding to the information of the uplink resources related to the measurement for the terminal apparatus 300.

Moreover, the terminal apparatus 300 (receive processing unit 331) receives, from the source base station (base station 200), the handover command message including the information of the uplink resources related to the measurement for the terminal apparatus 300. The terminal apparatus 300 (transmit processing unit 333) then transmits a signal to the target base station (base station 100) by using the information of the uplink resources related to the measurement.

In particular, the base station 100 (second communication processing unit 143) receives the signal transmitted from the terminal apparatus 300, based on the information of the uplink resources related to the measurement for the terminal apparatus 300.

(1) Uplink Resources Related to Measurement for Terminal Apparatus 300

The measurement for the terminal apparatus 300 is, for example, measurement performed by the terminal apparatus 300. Specifically, the uplink resources related to the measurement for the terminal apparatus 300 are, for example, resources for the terminal apparatus 300 to transmit measurement information.

The measurement for the terminal apparatus 300 may, for example, be measurement performed by the base station 100 for the terminal apparatus 300. Specifically, the uplink resources related to the measurement for the terminal apparatus 300 may, for example, be resources for transmitting an uplink reference signal to be used for measurement for the terminal apparatus 300 (measurement to be performed by the base station 100).

Measurement Information

The information of the uplink resources related to the measurement for the terminal apparatus 300 may, for example, include information related to resources for the terminal apparatus 300 to transmit measurement information. Concretely, the information of the uplink resources related to the measurement for the terminal apparatus 300 may include information indicating resources for the terminal apparatus 300 to transmit the measurement information.

More concretely, the measurement information is, for example, channel state information (CSI). In other words, the information of the uplink resources related to the measurement for the terminal apparatus 300 is information indicating uplink resources for the terminal apparatus 300 to transmit CSI (CSI resource indication information).

For example, the target base station (acquisition unit 131 of the base station 100) allocates resources for the terminal apparatus 300 to transmit the CSI in uplink resources, based on uplink resource allocation information or the like, to thereby acquire the CSI resource indication information. The CSI resource indication information is transmitted from the source base station (base station 200) to the terminal apparatus 300.

Meanwhile, for example, after the terminal apparatus 300 receives the handover command message from the source base station (base station 200), the terminal apparatus 300 (transmit processing unit 333) maps the CSI to the uplink resources indicated by the CSI resource indication information to transmit the CSI to the target base station (base station 200).

In this way, after the reception of the handover message, the terminal apparatus 300 can promptly transmit the CSI to the target base station (base station 200).

Uplink Reference Signal

The information of the uplink resources related to the measurement for the terminal apparatus 300 may, for example, include information related to resources for the terminal apparatus 300 to transmit an uplink reference signal. Concretely, the information of the uplink resources related to the measurement for the terminal apparatus 300 may include information indicating resources for the terminal apparatus 300 to transmit the uplink reference signal.

The uplink reference signal is, for example, a reference signal to be used by the base station 100 for measurement for the terminal apparatus 300. More concretely, the uplink reference signal is, for example, a sounding reference signal (SRS). In other words, the information of the uplink resources related to the measurement for the terminal apparatus 300 is information indicating uplink resources for the terminal apparatus 300 to transmit a SRS (SRS resource indication information).

For example, the target base station (acquisition unit 131 of the base station 100) allocates resources for the terminal apparatus 300 to transmit the SRS in uplink resources, based on uplink resource allocation information or the like, to thereby acquire the SRS resource indication information. The SRS resource indication information is transmitted from the source base station (base station 200) to the terminal apparatus 300.

Meanwhile, for example, after the terminal apparatus 300 receives the handover command message from the source base station (base station 200), the terminal apparatus 300 (transmit processing unit 333) maps the SRS to the uplink resources indicated by the SRS resource indication information, to transmit the SRS to the target base station (base station 200). In this way, after the reception of the handover message, the terminal apparatus 300 can promptly transmit the SRS to the target base station (base station 200).

(2) Handover Message

As described above, the base station 200 (source base station) transmits, to the base station 100 (target base station), the handover message including the information of the uplink resources related to the measurement for the terminal apparatus 300. The handover message may be directly transmitted from the base station 200 to the base station 100 (e.g., a case of X2 handover) or may be transmitted from the base station 200 to the base station 100 through a core network (e.g., a case of S1 handover).

For example, the handover message is a handover request (HANDOVER REQUEST) message. Moreover, the response message is a handover request acknowledge (HANDOVER REQUEST ACKNOWLEDGE) message. In the following, an example of the first example embodiment will be described by assuming that the handover message is a handover request message and the response message is the handover request acknowledge message. However, in the first example embodiment, the handover message is not limited to a handover request message, and another message transmitted from the source base station to the target base station in a handover procedure may be used as the handover message, instead.

(3) Beam Related Information

For example, the handover message may include beam related information related to a beam(s). Specifically, the base station 100 (first communication processing unit 141) may receive the handover message including the beam related information from the source base station (base station 200).

In this case, the information of the uplink resources related to the measurement for the terminal apparatus 300 may be information of uplink resources in radio resources selected based on the beam related information, the information being information of uplink resources related to the measurement for the terminal apparatus 300. For example, the base station 100 (acquisition unit 145) allocates the uplink resources related to the measurement for the terminal apparatus 300 in radio resources selected based on the beam related information, to be thereby able to acquire the information of the uplink resources related to the measurement for the terminal apparatus 300.

(3-1) Beam Related Information

The beam related information may, for example, be second beam related information corresponding to first beam related information transmitted from the terminal apparatus 300 to the source base station (base station 200).

Specifically, the terminal apparatus 300 (transmit processing unit 333) transmits the first beam related information to the source base station (base station 200). Meanwhile, the base station 200 (second communication processing unit 243) receives the first beam related information from the terminal apparatus 300. Then, the base station 200 (second communication processing unit 243) transmits, to the target base station (base station 100), a handover message including the second beam related information corresponding to the first beam related information.

First Beam Related Information

The first beam related information is, for example, information related to a beam(s) transmitted through beamforming by the target base station (base station 100).

Concretely, the first beam related information is information related to a reference signal transmitted through beamforming by the target base station (base station 100).

(Reference Signal Transmitted from Target Base Station)

For example, the base station 100 (first communication processing unit 141) transmits a reference signal on a plurality of beams. The plurality of beams may be considered as beams for the base station 100 to transmit a signal (or beams formed by the base station 100 to transmit a signal). The plurality of beams are beams directed at different directions. The beams here mean directional beams and are formed, for example, in such a manner that a signal is multiplied by a set of beamforming weights and signals resulting from the multiplication are transmitted through a directional antenna. A description will be given below of a concrete example of the plurality of beams with reference to FIG. 5.

FIG. 5 is an explanatory diagram for describing an example of a plurality of beams on which a reference signal is transmitted. With reference to FIG. 5, the base station 100, the coverage area 10, and 16 beams 11 (beams 11A to 11P) are illustrated. For example, as illustrated, the base station 100 transmits a reference signal on the 16 beams 11. As an example, each beam is identified by a beam index (or weight index). For example, a beam 11A is identified by an index #0, and a beam 11J is identified by an index #9.

(Acquisition of First Beam Related Information)

For example, the first beam related information may be acquired based on measurement results of a reference signal transmitted through beamforming by the target base station (base station 100). The first beam related information may be included in a measurement report to the source base station (base station 200).

More specifically, the terminal apparatus 300 performs measurement on the reference signal transmitted on each beam as illustrated in FIG. 5 and selects a beam with a preferred measurement result (e.g., preferred reception power or reception quality). In other words, the terminal apparatus 300 selects preferred beamforming weights. The terminal apparatus 300 then transmits, to the base station 200, a measurement report including first beam related information related to the selected beam and the preferred measurement result.

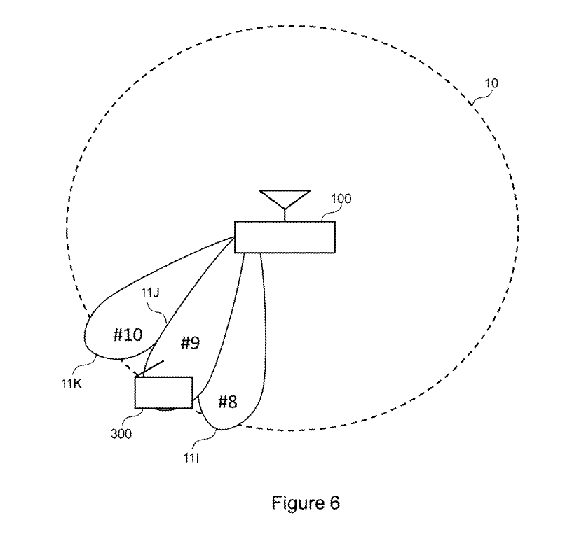

FIG. 6 is an explanatory diagram for describing an example of a measurement report by the terminal apparatus 300. With reference to FIG. 6, the base station 100 and the terminal apparatus 300 are illustrated. For example, the terminal apparatus 300 performs measurement on the reference signal transmitted on each beam and selects beams #8, #9, and #10 (beams 11I, 11J, and 11K) with preferred measurement results. The terminal apparatus 300 then transmits, to the base station 200, a measurement report including first beam related information (e.g., beam indices/weight indices #8, #9, and #10) related to the beams #8, #9, and #10 (beams 11I, 11J, and 11K) and the preferred measurement results.

In this way, for example, the base station 200 can acquire first beam related information on the base station 100 through the measurement report.

Second Beam Related Information

As described above, the second beam related information corresponds to the first beam related information.

For example, the second beam related information is the same information as the first beam related information. Specifically, the base station 200 includes, in a handover request message, the second beam related information, which is the same as the first beam related information received from the terminal apparatus 300, and transmits the handover request message to the base station 100.

Alternatively, the second beam related information may be information different from the first beam related information. For example, the base station 100 may convert the first beam related information to the second beam related information and transmit, to the base station 100, a handover request message including the second beam related information.

Example of Beam Related Information

The beam related information (first beam related information and second beam related information) is information related to a beam(s). Each beam is formed by using beamforming weights (set of beamforming weights), and hence the beam and the set of beamforming weights may have one-by-one correspondence. For this reason, the beam related information can be considered as information related to beamforming weights (e.g., weight related information).

The beam related information is information of the base station 100. For example, the beam related information is information related to a beam(s) of the base station 100 (beam(s) that the base station 100 uses for signal transmission).

For example, the beam related information is information related to one or more beams of a plurality of beams. Concretely, for example, the beam related information is information indicating one or more of the plurality of beams, in other words, information that makes it possible to identify the one or more of the plurality of beams (e.g., beam identification information). As an example, the beam related information is a beam index (indices). Alternatively, the beam related information may be information indicating one or more set of a plurality of sets of beamforming weights, in other words, information that makes it possible to identify the one or more sets of the plurality of sets (e.g., weight identification information). As an example, the beam related information may be a weight index (indices). Each beam is formed by using a set of beamforming weights, and hence the beam and the set of beamforming weights may have one-by-one correspondence. Hence, the beam related information may be information indicating the one or more of the plurality of beams (one or more beam indices) and may be the information indicating one or more of the plurality of sets (one or more weight indices). In other words, the beam indices and the weight indices may be the same indices although being referred to differently. The beam related information may, of course, be information with another name (beam ID, weight ID, beamforming index, beamforming ID, or the like) that makes it possible to identify a beam or a set of beamforming weights.

(3-2) Radio Resources Selected Based on Beam Related Information

As described above, the information of the uplink resources related to the measurement for the terminal apparatus 300 may be information of uplink resources in radio resources selected based on the beam related information, the information being information of uplink resources related to the measurement for the terminal apparatus 300.

For example, the information of the uplink resources related to the measurement for the terminal apparatus 300 is information of uplink resources in radio resources corresponding to one or more beams selected based on the beam related information, the information being information of uplink resources related to the measurement for the terminal apparatus 300. Alternatively, the information of the uplink resources related to the measurement for the terminal apparatus 300 may be information of uplink resources in radio resources corresponding to one or more sets of beamforming weights selected based on the beam related information, the information being information of uplink resources related to the measurement for the terminal apparatus 300.

Concretely, the information of the uplink resources related to the measurement for the terminal apparatus 300 includes identification information of one or more beams/sets of beamforming weights selected based on the beam related information, and information of uplink resources in the radio resources corresponding to the beam(s)/set(s) of beamforming weights identified by the identification information, the information being information indicating resources for CSI and/or SRS (CSI/SRS resource indication information).

The terminal apparatus 300 (transmit processing unit 333) transmits a signal (e.g., CSI and/or SRS, or the like) to the target base station (base station 100), based on the information of the uplink resources related to the measurement for the terminal apparatus 300 by using the radio resources selected based on the beam related information (radio resources selected based on the second beam related information corresponding to the first beam related information).

Meanwhile, the base station 100 (second communication processing unit 143), which is the target base station, receives the signal (e.g., CSI and/or SRS) transmitted from the terminal apparatus 300, based on the uplink resources related to the measurement for the terminal apparatus 300, by using the one or more sets of beamforming weights corresponding to the radio resources selected based on the beam related information.

This will be described with the concrete example illustrated in FIG. 6. In a case that the first beam related information indicates the beams #8, #9, and #10 with preferred measurement results and the first beam related information and the second beam related information are the same, the uplink resources related to the measurement for the terminal apparatus 300 are allocated in the radio resources selected based on the beam related information as will be described below.

Specifically, the target base station (base station 100) selects one or multiple beams from three beam candidates (beams #8, #9, and #10) with preferred measurement results, based on the first beam related information. In a case that one beam #9 is selected, for example, the base station 100 (e.g., the acquisition unit 145) can allocate the uplink resources related to the measurement for the terminal apparatus 300 in the radio resources corresponding to the beam #9.

In this way, the base station 100 (acquisition unit 145) can acquire the information of the uplink resources related to the measurement for the terminal apparatus 300 in the radio resources in which uplink resources corresponds to the beam #9.

The terminal apparatus 300 (transmit processing unit 333) maps, to the radio resource corresponding to the beam #9, the information related to the measurement for the terminal apparatus 300, e.g., CSI, SRS, and the like, based on the information of the uplink resources related to the measurement for the terminal apparatus 300, to thereby be able to transmit the information to the target base station (base station 100).

Meanwhile, the base station 100 (second communication processing unit 143) can receive a signal (e.g., CSI, SRS, and the like) transmitted from the terminal apparatus 300, by using the set of beamforming weights corresponding to the beam #9.

(4) Flow of Processing

Example of Processing according to First Example Embodiment

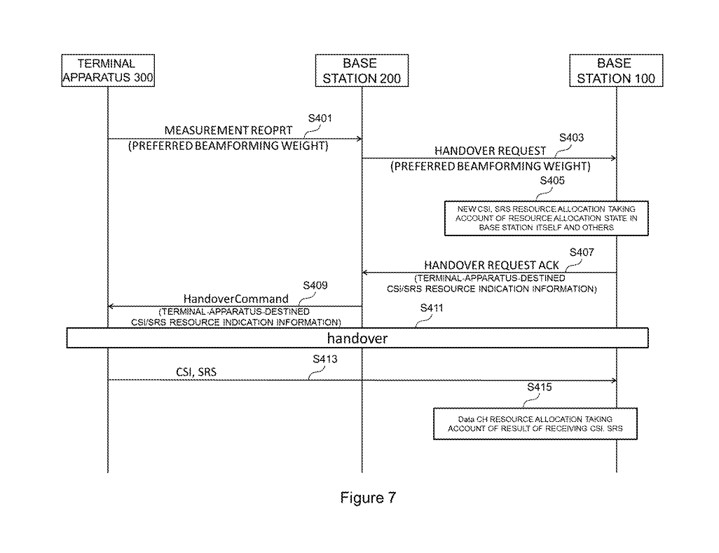

With reference to FIG. 7, an example of processing according to the first example embodiment will be described. FIG. 7 is a sequence diagram for describing an example of a schematic flow of the processing according to the first example embodiment.

The terminal apparatus 300 performs measurement on the reference signal transmitted from the base station 100 through beamforming to select preferred beamforming weights. The terminal apparatus 300 then transmits, to the base station 200 (source base station), a measurement report including a weight index (indices) indicating the preferred beamforming weights (S401). The measurement report includes, for example, a measurement result of the reference signal.

Thereafter, handover of the terminal apparatus 300 from the base station 200 (source base station) to the base station 100 (target base station) is determined, and the base station 200 transmits, to the base station 100, a handover request message including the weight index indicating the preferred beamforming weights (S403).

Upon acquisition of the weight index included in the handover request message, the base station 100 selects one or more beams, based on the weight index, a resource allocation state in the base station itself (base station 100), and the like. The base station 100 then allocates uplink resources for the terminal apparatus 300 to newly transmit CSI and SRS, in the radio resources corresponding to the beam selected based on the resource allocation state in the base station itself (base station 100) and the like (S405).

The base station 100 thereafter transmits, to the base station 200, a handover request acknowledge (HANDOVER REQUEST ACKNOWLEDGE) message including information indicating uplink resources for transmitting the CSI and the SRS (terminal-apparatus-destined CSI/SRS resource indication information) (S407). Here, the handover request acknowledge (HANDOVER REQUEST ACKNOWLEDGE) message also includes a handover command (HandoverCommand) message in an RRC layer, which is equivalent to indication of handover.

The base station 200 transmits, to the terminal apparatus 300, an RRC signal (e.g., an RRCConnectionReconfiguration message) including terminal-apparatus-destined CSI/SRS resource indication information and the handover command (HandoverCommand) message (S409).

Thereafter, upon completion of the handover (S411), the terminal apparatus 300 transmits the CSI and the SRS to the base station 100 by using uplink resources indicated by the terminal-apparatus-destined CSI/SRS resource indication information (S413).

The base station 100 thereafter performs Data CH resource allocation, based on a result of receiving the CSI and the SRS transmitted from the terminal apparatus 300 (S415).

Note that the above-described example of the flow of the processing is merely a schematic flow, and transmission and reception other than Steps S401 to S415 described above may, of course, be performed in the first example embodiment.

Processing According to Comparative Example of First Example Embodiment

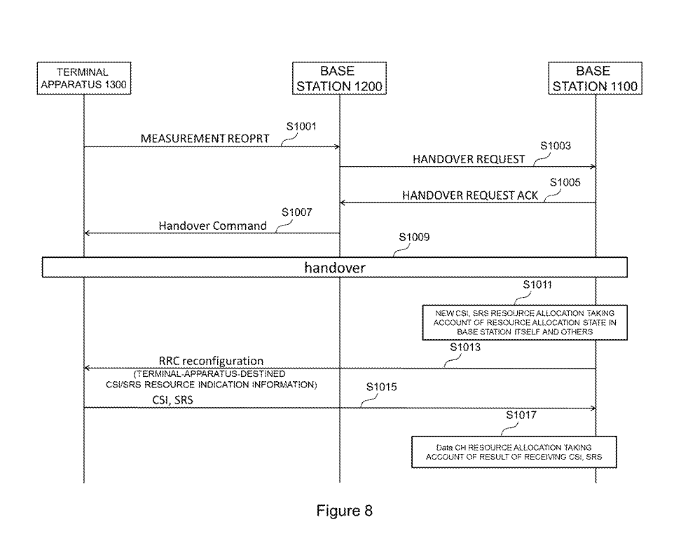

Next, with reference to FIG. 8, processing according to a comparative example of the first example embodiment will be described. FIG. 8 is a sequence diagram for describing an example of a schematic flow of processing according to the comparative example of the first example embodiment.

A terminal apparatus 1300 performs measurement on the reference signal transmitted from a base station 1100 and transmits a measurement report to a base station 1200 (serving base station) (S1001). Subsequently, handover of the terminal apparatus 1300 from the base station 1200 (source base station) to the base station 1100 (target base station) is determined, and the base station 1200 transmits a handover request message to the base station 1100 (S1003). The base station 1100 then transmits, to the base station 1200, a handover request acknowledge (HANDOVER REQUEST ACKNOWLEDGE) message including a handover command (HandoverCommand) message in an RRC layer, which is equivalent to indication of handover (S1005). The base station 1200 thereafter transmits, to the terminal apparatus 1300, an RRC signal (e.g., an RRCConnectionReconfiguration message) including the handover command (HandoverCommand) message (S1007).

Thereafter, upon completion of the handover (S1009), the base station 1100 allocates uplink resources for the terminal apparatus 1300 to newly transmit CSI and SRS, based on a resource allocation state in the base station itself (base station 1100) and the like (S1011). The base station 1100 then transmits, to the terminal apparatus 1300, an RRC signal (e.g., an RRCConnectionReconfiguration message) including information indicating the uplink resources for transmitting CSI and SRS (terminal-apparatus-destined CSI/SRS resource indication information) (S1013). The terminal apparatus 1300 then transmits CSI and SRS to the base station 1100 by using the uplink resources indicated by the terminal-apparatus-destined CSI/SRS resource indication information (S1015). The base station 1100 then performs Data CH resource allocation, based on a result of receiving the CSI and the SRS transmitted from the terminal apparatus 1300 (S1017).

Evaluation

According to the processing illustrated in FIG. 7 described above, terminal-apparatus-destined CSI/SRS resource indication information is included in the handover request acknowledge and the handover command. Hence, for example, Data CH resource allocation taking account of a terminal apparatus immediately after handover can be performed at earlier timing according to the above-described processing illustrated in FIG. 7, in comparison, for example, with the case of allocating, after completion of handover, uplink resources for the terminal apparatus 300 to newly transmit CSI and SRS as in the above-described processing illustrated in FIG. 8. This consequently enables a prompt increase in throughput of the terminal apparatus immediately after handover.

(5) Meaning of “Transmit”

“Transmit” here means, for example, to perform transmit processing in at least one protocol layer among a plurality of protocol layers and does not necessarily mean to output any signal with wire or wirelessly. Similarly, “receive” here means, for example, to perform receive processing in at least one protocol layer among a plurality of protocol layers. As an example, the plurality of protocol layers are the physical layer, the Media Access Control (MAC) layer, the Radio Link Control (RLC) layer, the Packet Data Convergence Protocol (PDCP) layer, and the Radio Resource Control (RRC) layer. As another example, the plurality of protocol layers are the physical layer, the MAC layer, the Internet Protocol (IP) layer, and the transport layer.

Moreover, “transmit X to Y” here is not limited to transmitting X directly to Y and includes transmitting X indirectly to Y (specifically, a case in which X is transmitted to another node, and after the transfer from the node, X is transmitted to Y). Similarly, “receive X from Y” here is not limited to receiving X directly from Y and includes receiving X indirectly from Y (specifically, X transmitted from Y is received after transfer from another node).

### 3. Second Example Embodiment

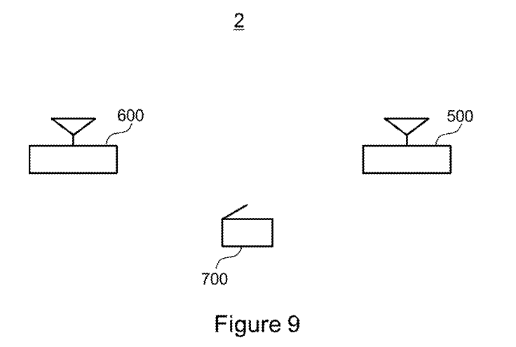

Next, a description will be given of a second example embodiment of the present invention with reference to FIG. 9 to FIG. 12. The above-described first example embodiment is a concrete example embodiment, whereas the second example embodiment is a more generalized example embodiment.

<3.1. Configuration of System>

With reference to FIG. 9, an example of a configuration of a system 2 according to the second example embodiment will be described. FIG. 9 is an explanatory diagram illustrating an example of a schematic configuration of the system 2 according to the second example embodiment. According to FIG. 9, the system 2 includes a base station 500, a base station 600, and a terminal apparatus 700.

For example, the system 2 may be a system conforming to 3GPP standards. More concretely, for example, the system 2 may be a system conforming to 5G standards.

For example, descriptions of the base station 500, the base station 600, and the terminal apparatus 700 are the same as the descriptions of the base station 100, the base station 200, and the terminal apparatus 300 of the first example embodiment. Therefore, duplicated descriptions are omitted here.

<3.2. Configuration of Base Station 500>

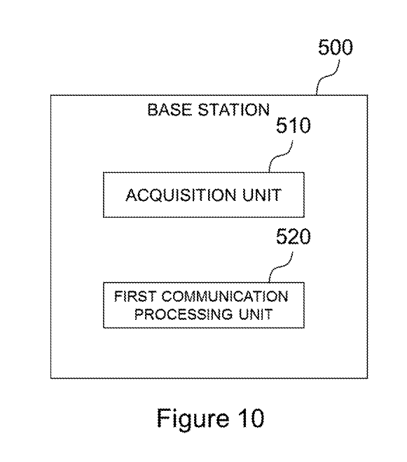

Next, with reference to FIG. 10, an example of a configuration of the base station 500 according to the second example embodiment will be described. FIG. 10 is a block diagram illustrating an example of a schematic configuration of the base station 500 according to the second example embodiment. According to FIG. 10, the base station 500 includes an acquisition unit 510 and a first communication processing unit 520.

Concrete operations of the acquisition unit 510 and the first communication processing unit 520 will be described later.

The acquisition unit 510 and the first communication processing unit 520 may be implemented by a baseband (BB) processor and/or a different processor, or the like. The acquisition unit 510 and the first communication processing unit 520 may be implemented by the same processor or may be implemented by separate processors.

The base station 500 may include a memory configured to store a program and one or more processors that can execute the program, and the one or more processors may perform operations of the acquisition unit 510 and the first communication processing unit 520. The program may be a program for causing the one or more processors to perform the operations of the acquisition unit 510 and the first communication processing unit 520.

<3.3. Configuration of Base Station 600>

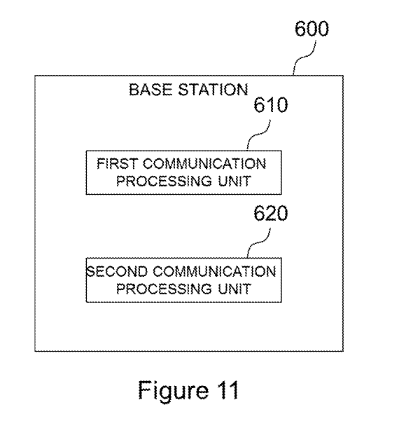

Next, an example of a configuration of the base station 600 according to the second example embodiment will be described with reference to FIG. 11. FIG. 11 is a block diagram illustrating an example of a schematic configuration of the base station 600 according to the second example embodiment. According to FIG. 11, the base station 600 includes a first communication processing unit 610 and a second communication processing unit 620.

Concrete operations of the first communication processing unit 610 and the second communication processing unit 620 will be described later.

The first communication processing unit 610 and the second communication processing unit 620 may be implemented by a baseband (BB) processor and/or a different processor, or the like. The first communication processing unit 610 and the second communication processing unit 620 may be implemented by the same processor or may be implemented by separate processors.

The base station 600 may include a memory configured to store a program and one or more processors that can execute the program, and the one or more processors may perform operations of the first communication processing unit 610 and the second communication processing unit 620. The program may be a program for causing the one or more processors to perform the operations of the first communication processing unit 610 and the second communication processing unit 620.

<3.4 Configuration of Terminal Apparatus 700>

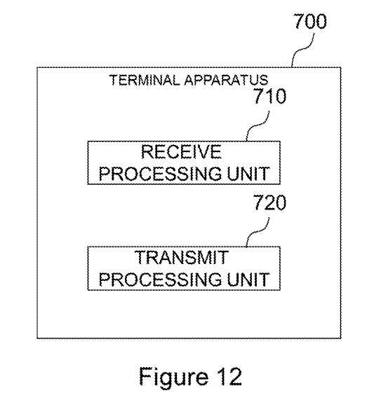

Next, an example of a configuration of the terminal apparatus 700 according to the second example embodiment will be described with reference to FIG. 12. FIG. 12 is a block diagram illustrating an example of a schematic configuration of the terminal apparatus 700 according to the second example embodiment. According to FIG. 12, the terminal apparatus 700 includes a receive processing unit 710 and a transmit processing unit 720.

Concrete operations of the receive processing unit 710 and the transmit processing unit 720 will be described later.

The receive processing unit 710 and the transmit processing unit 720 may be implemented by a baseband (BB) processor and/or a different processor, or the like. The receive processing unit 710 and the transmit processing unit 720 may be implemented by the same processor or may be implemented by separate processors.

The terminal apparatus 700 may include a memory configured to store a program and one or more processors that can execute the program, and the one or more processors may perform operations of the receive processing unit 710 and the transmit processing unit 720. The program may be a program for causing the one or more processors to perform the operations of the receive processing unit 710 and the transmit processing unit 720.

<3.5. Technical Features>

Next, technical features of the second example embodiment will be described.

In the second example embodiment, the base station 500 (acquisition unit 510) acquires a response message for a handover message from the source base station (base station 600) of handover of the terminal apparatus 700, the response message including information of uplink resources related to measurement for the terminal apparatus 700. Then, the base station 500 (first communication processing unit 520) transmits the response message for the handover message to the source base station (base station 600).

Note that the acquisition unit 510 may operate similarly to the acquisition unit 145 of the first example embodiment, and the first communication processing unit 520 may operate similarly to the first communication processing unit 141 of the first example embodiment.

In addition, the base station 600 (first communication processing unit 610) receives, from the target base station (base station 500) of the handover of the terminal apparatus 700, the response message including the information of the uplink resources related to the measurement for the terminal apparatus 700. The base station 600 (second communication processing unit 620) then transmits, to the terminal apparatus 700, a handover command message including information corresponding to the information of the uplink resources related to the measurement for the terminal apparatus 700.

Note that the first communication processing unit 610 may operate similarly to the first communication processing unit 241 of the first example embodiment, and the second communication processing unit 620 may operate similarly to the second communication processing unit 243 of the first example embodiment.

Moreover, the terminal apparatus 700 (receive processing unit 710) receives, from the source base station (base station 600), the handover command message including the information of the uplink resources related to the measurement for the terminal apparatus 700. The terminal apparatus 700 (transmit processing unit 720) then transmits a signal to the target base station (base station 500) by using the information of the uplink resources related to the measurement.

Note that the receive processing unit 710 may operate similarly to the receive processing unit 331 of the first example embodiment, and the transmit processing unit 720 may operate similarly to the transmit processing unit 333 of the first example embodiment.

With this configuration, for example, it is possible to reduce time for data channel (Data CH) assignment taking account of the terminal apparatus immediately after handover. This consequently enables a prompt increase in throughput of a terminal apparatus immediately after handover.

### 4. Other Example Embodiments

Descriptions have been given above of the example embodiments of the present invention. However, the present invention is not limited to these example embodiments. It should be understood by those skilled in the art that these example embodiments are merely examples and that various modifications are possible without departing from the scope and the spirit of the present invention.

For example, the steps in the processing described herein may not be necessarily performed in the order described in the corresponding sequence diagram in time series. For example, the steps in the processing may be performed in an order different from or in parallel with the order described in the sequence diagram. In addition, some of the steps in the processing may be deleted, or more steps may be added to the processing.

An apparatus including constituent elements of the base station described herein (e.g., the first communication processing unit, the second communication processing unit, and/or the acquisition unit) (e.g., one or more apparatuses (or units) among a plurality of apparatuses (or units) constituting the base station or a module for one of the plurality of apparatuses (or units)) may be provided. An apparatus including the constituent elements of the terminal apparatus described herein (e.g., the receive processing unit and/or the transmit processing unit) (e.g., a module for the terminal apparatus) may be provided. Moreover, methods including processing of the constituent elements may be provided, and programs or program products for causing a processor to execute processing of the constituent elements may be provided. Moreover, a non-transitory computer readable recording medium (non-transitory computer readable medium) recording the programs may be provided. It is apparent that such apparatuses, modules, methods, programs, and a non-transitory computer readable recording medium are also included in the present invention.

The whole or part of the example embodiments disclosed above can be described as, but not limited to, the following supplementary notes.

(Supplementary Note 1)

An apparatus comprising: an acquisition unit configured to acquire a response message for a handover message from a source base station of handover of a terminal apparatus, the response message including information of uplink resources related to measurement for the terminal apparatus; and

a first communication processing unit configured to transmit the response message for the handover message to the source base station.

(Supplementary Note 2)

The apparatus according to Supplementary Note 1, in which the information of the uplink resources related to the measurement for the terminal apparatus includes information related to resources for the terminal apparatus to transmit measurement information.

(Supplementary Note 3)

The apparatus according to Supplementary Note 2, in which the information of the uplink resources related to the measurement for the terminal apparatus includes information indicating the resources for the terminal apparatus to transmit the measurement information.

(Supplementary Note 4)

The apparatus according to Supplementary Note 2 or 3, in which the measurement information is channel state information (CSI).

(Supplementary Note 5)

The apparatus according to any one of Supplementary Notes 1 to 4, in which the information of the uplink resources related to the measurement for the terminal apparatus includes information related to resources for the terminal apparatus to transmit an uplink reference signal.

(Supplementary Note 6)

The apparatus according to Supplementary Note 5, in which the information of the uplink resources related to the measurement for the terminal apparatus includes information indicating the resources for the terminal apparatus to transmit the uplink reference signal.

(Supplementary Note 7)

The apparatus according to Supplementary Note 5 or 6, in which the uplink reference signal is a sounding reference signal (SRS).

(Supplementary Note 8)

The apparatus according to any one of Supplementary Notes 1 to 7, in which the information of the uplink resources related to the measurement for the terminal apparatus is information to be transmitted from the source base station to the terminal apparatus.

(Supplementary Note 9)

The apparatus according to Supplementary Note 8, further comprising a second communication processing unit configured to receive a signal transmitted from the terminal apparatus, based on the information of the uplink resources related to the measurement for the terminal apparatus.

(Supplementary Note 10)

The apparatus according to any one of Supplementary Notes 1 to 8, in which

the first communication processing unit receives, from the source base station, the handover message including beam related information related to a beam, and

the information of the uplink resources related to the measurement for the terminal apparatus is information of uplink resources in radio resources selected based on the beam related information, the information being information of uplink resources related to the measurement for the terminal apparatus.

(Supplementary Note 11)

The apparatus according to Supplementary Note 10, further comprising a second communication processing unit configured to transmit a beam through beamforming, in which

the beam related information is information related to a beam transmitted by the apparatus through beamforming.

(Supplementary Note 12)

The apparatus according to Supplementary Note 10, further comprising a second communication processing unit configured to receive a signal transmitted from the terminal apparatus, based on the information of the uplink resources related to the measurement for the terminal apparatus, by using one or more sets of beamforming weights corresponding to the radio resources selected based on the beam related information.

(Supplementary Note 13)

The apparatus according to any one of Supplementary Notes 10 to 12, in which the beam related information is information related to one or more of a plurality of beams.

(Supplementary Note 14)

The apparatus according to Supplementary Note 13, in which the beam related information is information indicating one or more of the plurality of beams.

(Supplementary Note 15)

The apparatus according to Supplementary Note 13 or 14, in which the information of the uplink resources related to the measurement for the terminal apparatus is information of uplink resources in radio resources corresponding to one or more beams selected based on the beam related information, the information being information of uplink resources related to the measurement for the terminal apparatus.

(Supplementary Note 16)

The apparatus according to any one of Supplementary Notes 10 to 12, in which the beam related information is information indicating one or more sets of a plurality of sets of beamforming weights.

(Supplementary Note 17)

The apparatus according to Supplementary Note 15 or 16, in which the information of the uplink resources related to the measurement for the terminal apparatus is information of uplink resources in radio resources corresponding to one or more sets of beamforming weights selected based on the beam related information, the information being information of uplink resources related to the measurement for the terminal apparatus.

(Supplementary Note 18)

The apparatus according to any one of Supplementary Notes 10 to 17, in which the beam related information corresponds to beam related information transmitted from the terminal apparatus to the source base station.

(Supplementary Note 19)

The apparatus according to any one of Supplementary Notes 1 to 18, in which the apparatus is a base station, one or more apparatuses of a plurality of apparatuses constituting a base station, or a module for one of the plurality of apparatuses.

(Supplementary Note 20)

An apparatus comprising:

a first communication processing unit configured to receive a response message for a handover message transmitted from a target base station of handover of a terminal apparatus, the response message including information of uplink resources related to measurement for the terminal apparatus; and

a second communication processing unit configured to transmit, to the terminal apparatus, a handover command message including information corresponding to the information of the uplink resources related to the measurement for the terminal apparatus.

(Supplementary Note 21)

The apparatus according to Supplementary Note 20, in which the information of the uplink resources related to the measurement for the terminal apparatus includes information related to resources for the terminal apparatus to transmit measurement information.

(Supplementary Note 22)

The apparatus according to Supplementary Note 21, in which the information of the uplink resources related to the measurement for the terminal apparatus includes information indicating the resources for the terminal apparatus to transmit the measurement information.

(Supplementary Note 23)

The apparatus according to Supplementary Note 21 or 22, in which the measurement information of the terminal apparatus is channel state information (CSI).

(Supplementary Note 24)

The apparatus according to any one of Supplementary Notes 20 to 23, in which the information of the uplink resources related to the measurement for the terminal apparatus includes information related to resources for the terminal apparatus to transmit an uplink reference signal.

(Supplementary Note 25)

The apparatus according to Supplementary Note 24, in which the information of the uplink resources related to the measurement for the terminal apparatus includes information indicating the resources for the terminal apparatus to transmit the uplink reference signal.

(Supplementary Note 26)

The apparatus according to Supplementary Note 25, in which the uplink reference signal is a sounding reference signal (SRS).

(Supplementary Note 27)

The apparatus according to any one of Supplementary Notes 20 to 26, in which

the second communication processing unit receives, from the terminal apparatus, first beam related information related to a beam,

the first communication processing unit transmits, to the target base station, a handover message including second beam related information corresponding to the first beam related information, and

the information of the uplink resources related to the measurement for the terminal apparatus is information of uplink resources in radio resources selected based on the second beam related information, the information being information of uplink resources related to the measurement for the terminal apparatus.

(Supplementary Note 28)

The apparatus according to Supplementary Note 27, the first beam related information is information related to a beam transmitted by the target base station through beamforming.

(Supplementary Note 29)

The apparatus according to Supplementary note 27 or 28, in which the second beam related information is the same information as the first beam related information.

(Supplementary Note 30)

The apparatus according to any one of Supplementary Notes 27 to 29, in which

the second communication processing unit receives a measurement report transmitted from the terminal apparatus, and

the measurement report includes the first beam related information.

(Supplementary Note 31)

The apparatus according to any one of Supplementary Notes 20 to 30, in which the apparatus is a base station, one or more apparatuses of a plurality of apparatuses constituting a base station, or a module for one of the plurality of apparatuses.

(Supplementary Note 32)

An apparatus comprising:

a receive processing unit configured to receive, from a source base station of handover of a terminal apparatus, a handover command message including information of uplink resources related to measurement for the terminal apparatus; and

a transmit processing unit configured to transmit a signal to a target base station of the handover, based on the information of the uplink resources related to the measurement for the terminal apparatus.

(Supplementary Note 33)

The apparatus according to Supplementary Note 32, in which the information of the uplink resources related to the measurement for the terminal apparatus includes information related to resources for the terminal apparatus to transmit measurement information.

(Supplementary Note 34)

The apparatus according to Supplementary Note 33, in which the information of the uplink resources related to the measurement for the terminal apparatus includes information indicating the resources for the terminal apparatus to transmit the measurement information.

(Supplementary Note 35)

The apparatus according to Supplementary Note 33 or 34, in which the measurement information of the terminal apparatus is channel state information (CSI).

(Supplementary Note 36)

The apparatus according to any one of Supplementary Notes 32 to 35, in which the information of the uplink resources related to the measurement for the terminal apparatus includes information related to resources for the terminal apparatus to transmit an uplink reference signal.

(Supplementary Note 37)

The apparatus according to Supplementary Note 36, in which the information of the uplink resources related to the measurement for the terminal apparatus includes information indicating the resources for the terminal apparatus to transmit the uplink reference signal.

(Supplementary Note 38)

The apparatus according to Supplementary Note 37, in which the uplink reference signal is a sounding reference signal (SRS).

(Supplementary Note 39)

The apparatus according to any one of Supplementary Notes 32 to 38, in which

the transmit processing unit transmits, to the source base station, first beam related information related to a beam, and

the information of the uplink resources related to the measurement for the terminal apparatus is information of uplink resources in radio resources selected based on second beam related information corresponding to the first beam related information, the information being information of uplink resources related to the measurement for the terminal apparatus.

(Supplementary Note 40)

The apparatus according to Supplementary Note 39, the first beam related information is information related to a beam transmitted by the target base station through beamforming.

(Supplementary Note 41)

The apparatus according to Supplementary Note 39 or 40, in which

the transmit processing unit transmits a measurement report to the source base station, and

the measurement report includes the first beam related information.

(Supplementary Note 42)

The apparatus according to any one of Supplementary Notes 39 to 41, in which

the transmit processing unit transmits a signal to the target base station of the handover by using radio resources selected based on the second beam related information corresponding to the first beam related information, based on the information of the uplink resources related to the measurement for the terminal apparatus.

(Supplementary Note 43)

The apparatus according to any one of Supplementary Notes 32 to 41, in which the apparatus is a terminal apparatus or a module for a terminal apparatus.

(Supplementary Note 44)

A method including:

acquiring a response message for a handover message from a source base station of handover of a terminal apparatus, the response message including information of uplink resources related to measurement for the terminal apparatus; and

transmitting the response message for the handover message to the source base station.

(Supplementary Note 45)

A method including:

receiving a response message for a handover message transmitted to a target base station of handover of a terminal apparatus, the response message including information of uplink resources related to measurement for the terminal apparatus; and

transmitting, to the terminal apparatus, a handover command message including information corresponding to the information of the uplink resources related to the measurement for the terminal apparatus.

(Supplementary Note 46)

A method including:

receiving, from a source base station of handover of a terminal apparatus, a handover command message including information of uplink resources related to measurement for the terminal apparatus; and

transmitting a signal to a target base station of the handover, based on the information of the uplink resources related to the measurement for the terminal apparatus.

(Supplementary Note 47)

A program for causing a processor to execute:

acquiring a response message for a handover message from a source base station of handover of a terminal apparatus, the response message including information of uplink resources related to measurement for the terminal apparatus; and

transmitting the response message for the handover message to the source base station.

(Supplementary Note 48)

A program for causing a processor to execute:

receiving a response message for a handover message transmitted to a target base station of handover of a terminal apparatus, the response message including information of uplink resources related to measurement for the terminal apparatus; and

transmitting, to the terminal apparatus, a handover command message including information corresponding to the information of the uplink resources related to the measurement for the terminal apparatus.

(Supplementary Note 49)

A program for causing a processor to execute:

receiving, from a source base station of handover of a terminal apparatus, a handover command message including information of uplink resources related to measurement for the terminal apparatus; and

transmitting a signal to a target base station of the handover, based on the information of the uplink resources related to the measurement for the terminal apparatus.

(Supplementary Note 50)

A non-transitory readable recording medium recording a program for causing a processor to execute:

acquiring a response message for a handover message from a source base station of handover of a terminal apparatus, the response message including information of uplink resources related to measurement for the terminal apparatus; and

transmitting the response message for the handover message to the source base station.

(Supplementary Note 51)

A non-transitory readable recording medium recording a program for causing a processor to execute:

receiving a response message for a handover message transmitted from a target base station of handover of a terminal apparatus, the response message including information of uplink resources related to measurement for the terminal apparatus; and

transmitting, to the terminal apparatus, a handover command message including information corresponding to the information of the uplink resources related to the measurement for the terminal apparatus.

(Supplementary Note 52)

A non-transitory readable recording medium recording a program for causing a processor to execute:

receiving, from a source base station of handover of a terminal apparatus, a handover command message including information of uplink resources related to measurement for the terminal apparatus; and

transmitting a signal to a target base station of the handover, based on the information of the uplink resources related to the measurement for the terminal apparatus.

In a mobile communication system, throughput of a terminal apparatus immediately after handover can be promptly increased.

What is claimed is:

1. An apparatus comprising:
a memory storing a program; and
one or more processors configured to execute the program to:
acquire a response message for a handover message from a source base station of handover of a terminal apparatus, the response message including information of uplink resources related to measurement for the terminal apparatus; and
transmit the response message for the handover message to the source base station.

2. The apparatus according to claim 1, wherein the information of the uplink resources related to the measurement for the terminal apparatus includes information related to resources for the terminal apparatus to transmit measurement information.

3. The apparatus according to claim 2, wherein the information of the uplink resources related to the measurement for the terminal apparatus includes information indicating the resources for the terminal apparatus to transmit the measurement information.

4. The apparatus according to claim 2, wherein the measurement information is channel state information (CSI).

5. The apparatus according to claim 1, wherein the information of the uplink resources related to the measurement for the terminal apparatus includes information related to resources for the terminal apparatus to transmit an uplink reference signal.

6. The apparatus according to claim 5, wherein the information of the uplink resources related to the measurement for the terminal apparatus includes information indicating the resources for the terminal apparatus to transmit the uplink reference signal.

7. The apparatus according to claim 5, wherein the uplink reference signal is a sounding reference signal (SRS).

8. The apparatus according to claim 1, wherein the information of the uplink resources related to the measurement for the terminal apparatus is information to be transmitted from the source base station to the terminal apparatus.

9. The apparatus according to claim 8, wherein the one or more processors configured to execute the program to receive a signal transmitted from the terminal apparatus, based on the information of the uplink resources related to the measurement for the terminal apparatus.

10. The apparatus according to claim 1, wherein the one or more processors configured to execute the program to receive, from the source base station, the handover message including beam related information related to a beam, and
the information of the uplink resources related to the measurement for the terminal apparatus is information of uplink resources in radio resources selected based on the beam related information, the information being information of uplink resources related to the measurement for the terminal apparatus.

11. The apparatus according to claim 10, wherein the one or more processors configured to execute the program to transmit a beam through beamforming, and
the beam related information is information related to a beam transmitted by the apparatus through beamforming.

12. The apparatus according to claim 10, wherein the one or more processors configured to execute the program to receive a signal transmitted from the terminal apparatus, based on the information of the uplink resources related to the measurement for the terminal apparatus, by using one or more sets of beamforming weights corresponding to the radio resources selected based on the beam related information.

13. The apparatus according to claim 10, wherein the beam related information is information related to one or more of a plurality of beams.

14. The apparatus according to claim 13, wherein the beam related information is information indicating one or more of the plurality of beams.

15. The apparatus according to claim 13, wherein the information of the uplink resources related to the measurement for the terminal apparatus is information of uplink resources in radio resources corresponding to one or more beams selected based on the beam related information, the information being information of uplink resources related to the measurement for the terminal apparatus.

16. The apparatus according to claim 10, wherein the beam related information is information indicating one or more sets of a plurality of sets of beamforming weights.

17. The apparatus according to claim 15, wherein the information of the uplink resources related to the measurement for the terminal apparatus is information of uplink resources in radio resources corresponding to one or more sets of beamforming weights selected based on the beam related information, the information being information of uplink resources related to the measurement for the terminal apparatus.

18. The apparatus according to claim 10, wherein the beam related information corresponds to beam related information transmitted from the terminal apparatus to the source base station.

19. An apparatus comprising:
a memory storing a program; and
one or more processors configured to execute the program to:
receive a response message for a handover message transmitted from a target base station of handover of a terminal apparatus, the response message including information of uplink resources related to measurement for the terminal apparatus; and
transmit, to the terminal apparatus, a handover command message including information corresponding to the information of the uplink resources related to the measurement for the terminal apparatus.

20. A method including:
acquiring a response message for a handover message from a source base station of handover of a terminal apparatus, the response message including information of uplink resources related to measurement for the terminal apparatus; and
transmitting the response message for the handover message to the source base station.
